(19) United States
(12) Patent Application Publication
(10) Pub. No.: US 2012/0194054 A1
(43) Pub. Date: Aug. 2, 2012

(54) SOLID STATE LIGHT WITH OPTICAL DIFFUSER AND INTEGRATED THERMAL GUIDE

(75) Inventors: Raymond P. Johnston, Lake Elmo, MN (US); Martin Kristoffersen, Maplewood, MN (US); Michael A. Meis, Stillwater, MN (US); Robert L. Brott, Woodbury, MN (US)

(73) Assignee: 3M Innovative Properties Company

(21) Appl. No.: 13/019,498

(22) Filed: Feb. 2, 2011

(51) Int. Cl. H01J 7/24

(52) U.S. Cl. 313/46

(57) ABSTRACT

A solid state light having a solid state light source such as LEDs, an optical diffuser, and a thermal guide. The diffuser receives and distributes light from the light source, and the thermal guide is integrated with the optical diffuser for providing thermal conduction from the solid state light source and dissipating heat through convection and radiation for cooling the light. The interior surface of the optical diffuser can have extraction features for providing uniform distribution of light.

### BACKGROUND

The energy efficiency of lighting has become an important consideration in industrial, consumer, and architectural lighting applications. With the advances in solid state light technology, light emitting diodes (LEDs) have become more energy efficient than fluorescent lights. Further, the marketplace has a large established fixture base for Edison, fluorescent and high intensity discharge lights. These types of applications present a significant technical challenge for LEDs due to their inherent point source nature, and the need to operate the LEDs at relatively low temperatures. Today there are many solutions addressing these issues, including fans, thermal sinks, heat pipes and the like. However, these approaches limit the applications by adding complexity, cost, efficiency loss, added failure modes, and an undesirable form factor. The need remains to find a solution that can provide optical and electrical efficiency benefits, at attractive manufacturing costs and design.

### SUMMARY

A light, consistent with the present invention, includes a light source, an optical diffuser, and a thermal guide. The optical diffuser receives and distributes light from the light source, and the thermal guide is integrated with the optical diffuser for providing thermal conduction from the light source for cooling the light.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram illustrating a solid state light source with an optical guide and integrated thermal guide;

FIG. 2 is a cross sectional side view of a solid state light using an optical guide having an exterior portion for emitting light and an interior portion for cooling;

FIG. 3 is a top view of the light of FIG. 2;

FIG. 4 is a bottom view of the light of FIG. 2;

FIG. 5 is a cross sectional side view of a solid state light with an active cooling element;

FIG. 6 is an exploded perspective view of a solid state light with an optical diffuser;

FIG. 7 is a perspective view of the light of FIG. 6 as assembled;

FIG. 8 is a top view of the light of FIG. 6;

FIG. 9 is a bottom view of the light of FIG. 6;

FIG. 10 is a cross sectional side view of a first optical diffuser; and

FIG. 11 is a cross sectional side view of a second optical diffuser.

### DETAILED DESCRIPTION

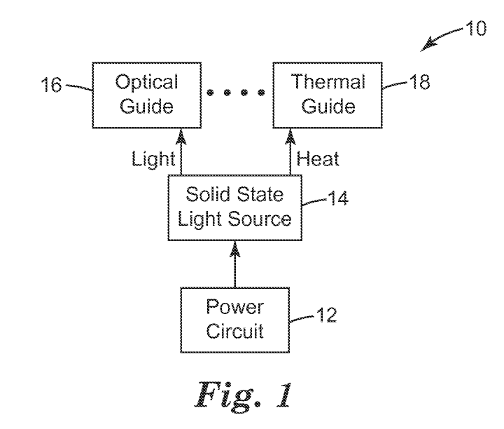

FIG. 1 is a diagram illustrating components of a light 10 having a power circuit 12, a solid state light source 14, and a thermo-optical guide comprising an optical guide 16 and an integrated thermal guide 18. Power circuit 12 receives power from a power supply and provides the required voltage and current to drive solid state light source 14, which is in optical communication with optical guide 16. Power circuit 12 is an optional element of light 10, if the power supply is configured to provide the required voltage and current directly to light 10 or if the circuit is external to light 10. Solid state light source 14 injects light into optical guide 16, which receives and distributes the light. Optical guide 16 includes light injection, light transport, and light extraction zones or elements in order to distribute the light. Thermal guide 18 is integrated with optical guide 16 in order to draw heat from solid state light source 14 through conduction and dissipate the heat through convection or radiation, or both, to cool light 10 and to efficiently utilize both area and volume for the cooling. Thermal guide 18 includes heat acquisition, heat spreading, and heat dissipation zones or elements in order to cool the light. Through integration of the optical and thermal guides, embodiments of this invention overcome many of the limitations of current solid state light concepts such as those identified above.

Solid state light source 14 can be implemented with, for example, LEDs, organic light emitting diodes (OLEDs), or other solid state light sources. Certain embodiments can provide for uniformly distributed light from the solid state light source. Alternatively, embodiments may be employed to control or direct light in a particular distribution. In one example, refraction can be used to control the emitted light; for example, lenses may be used to focus the light or reflectors may be used to concentrate or spread the light. For example, in certain embodiments the light can produce a cone or curtain of light. The lenses could have air permeability for cooling and can include Fresnel lenses, prismatic structures, or lenslet structures. In other embodiments, diffractive optics may be employed to control or direct both the spectrum and the distribution of the emitted light. For example, a diffractive lens may be used to direct a particular light distribution, or color from a broad light distribution, in a particular direction. Also, combinations of diffractive and refractive optics may be used.

The solid state light sources can emit light of various colors for decorative or other lighting effects. Solid state light source 14 is electrically connected with power circuit 12, which can include a flexible circuit or other circuitry for powering the solid state light source. The circuitry to power the light source can include dimming circuitry and electronics to control frequency shifting or color shifting components that help produce a more desirable light, and an example of such electronics are described in U.S. Patent Application Publication No. 2009/0309505, which is incorporated herein by reference as if fully set forth.

Optical guide 16 can be implemented with, for example, a transparent or translucent material capable of receiving light from the solid state light source and emitting the light. For example, optical guide 16 preferably is made of an optically suitable material such as polycarbonate, polyacrylates such as polymethyl methacrylate, polystyrene, glass, or any number of different plastic materials, elastic materials, and viscoelastic materials having sufficiently high refractive indexes for the optical guide to distribute light. The optical guide can be configured in a variety of shapes such as a bulb, sphere, cylinder, cube, sheet, or other shape. Furthermore, the optical guide can include a matrix material that can contain light frequency shifting material to obtain a more desirable color, and examples of matrix stabilized dyes are described in U.S. Pat. No. 5,387,458, which is incorporated herein by reference as if fully set forth.

Thermal guide 18 can be implemented with a material capable of conducting heat from the solid state light source and dissipating the heat. For example, the thermal guide is preferably comprised of a material with a thermal conductivity from about 1 W/(m-K) to 1000 W/(m-K), and more preferably from 10 W/(m-K) to 1000 W/(m-K), and most preferable from 100 W/(m-K) to 1000 W/(m-K). The thermal guide draws heat from the solid state light source through conduction and dissipates heat into air through convection or radiation, or both. Optionally, components of the thermal guide can include heat pipes and thermal siphons. Optionally, the thermal guide, or a portion thereof, can include a thermally conductive coating on the surfaces of the solid state light source; for example, carbon nanotubes that can transport heat from the solid state light source through conduction and convection may be coated onto the surfaces.

The thermal guide is integrated with the optical guide, meaning that the thermal guide is in sufficient contact, directly or indirectly, with the solid state light source in order to conduct and dissipate heat from the solid state light source for the light to function. For example, the thermal guide can draw heat from the solid state light sources to maintain the light sources cool enough to function as intended. The thermal guide can be directly in physical contact with the solid state light sources or indirectly in contact with them such as through a ring or other components upon which the solid state light sources are mounted. The thermal guide can also be in physical contact with the optical guide, either directly or indirectly through other components. Alternatively, the thermal guide need not be in physical contact with the optical guide, provided that the thermal guide can conduct sufficient heat from the solid state light sources in order for the light to function. Therefore, the thermal guide resides either co-extensively proximate to at least a portion or preferably a majority of the area of the optical guide, or the thermal guide resides within at least a portion or preferably a majority of the volume of the optical guide in the case of a bulb, sphere or other three dimensional shape having an interior volume.

The thermal guide can include thermal conductivity enhancements such as metal coatings or layers, or conductive particles, to help conduct the heat generated by the solid state light sources into and along the thermal guide. Further, the thermal guide can have convective thermal enhancements such as fins and microstructures to increase the convection and radiation heat transfer coefficient. The thermal guide can also have optical enhancements in order to enhance the light output of the optical guide. For example, the thermal guide can be formed from a reflective material or a material modified to have a reflective surface such as white paint, a polished surface, or a thin reflective material on its surface. The reflective surface can also be made from a material with high infrared emissivity in order to increase heat dissipation to the surroundings by thermal radiation.

Examples of solid state lights are disclosed in U.S. patent application Ser. No. 12/535203, entitled “Solid State Light with Optical Guide and Integrated Thermal Guide,” and filed Aug. 4, 2009; and U.S. patent application Ser. No. 12/960642, entitled “Solid State Light with Optical Guide and Integrated Thermal Guide,” and filed Dec. 6, 2010, both of which are incorporated herein by reference as if fully set forth. An example of a circuit for driving LEDs for a solid state light is disclosed in U.S. patent application Ser. No. 12/829611, entitled “Transistor Ladder Network for Driving a Light Emitting Diode Series String,” and filed Jul. 2, 2010, which is incorporated herein by reference as if fully set forth.

Optical Guide with Integrated Thermal Guide

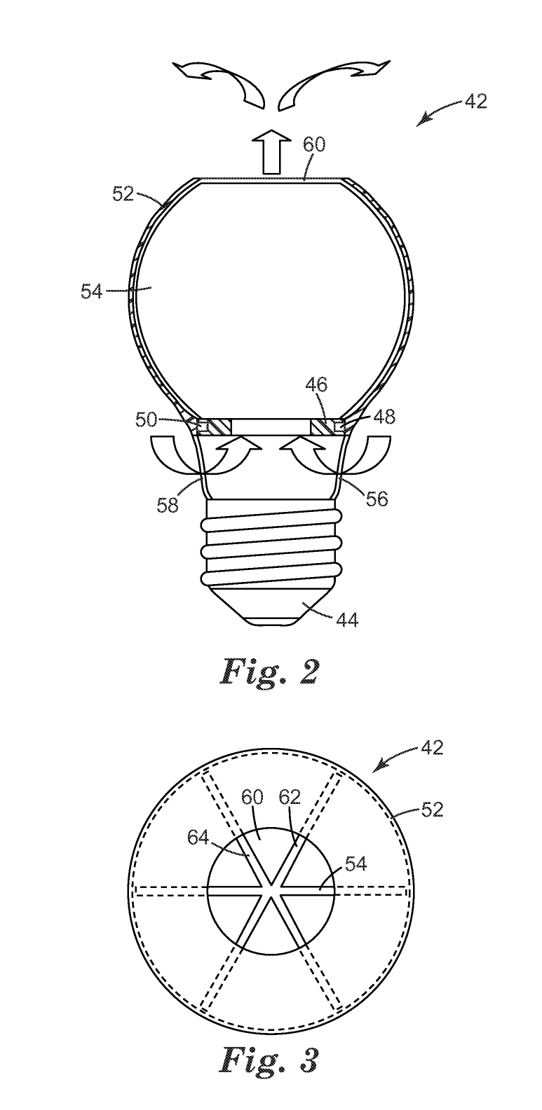

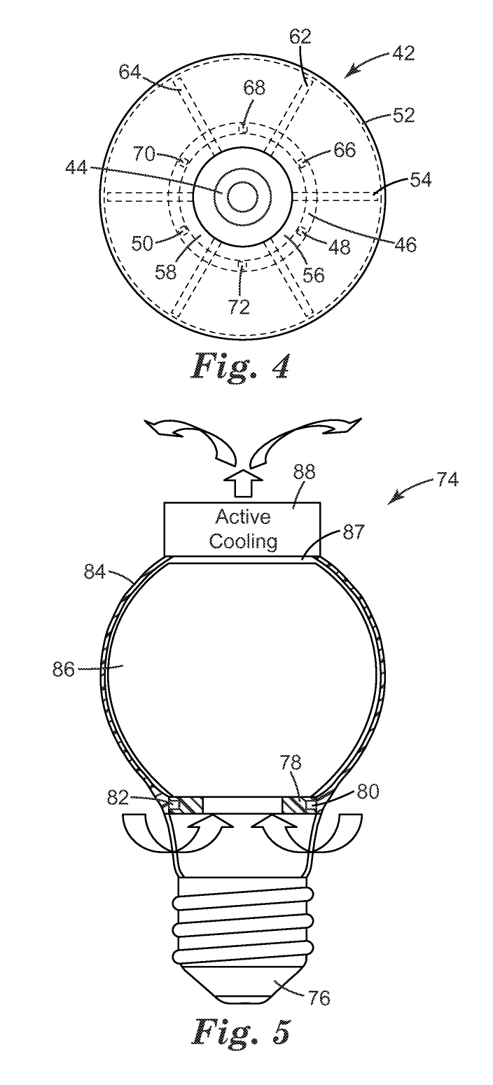

FIG. 2 is a cross sectional side view of an embodiment of a solid state light 42 using an optical guide having an exterior portion for emitting light and an interior portion for cooling. FIGS. 3 and 4 are top and bottom views, respectively of light 42. Light 42 includes an optical guide 52, integrated thermal guide 54, and solid state light sources on an optional heat spreader ring 46. The heat spreader ring 46 can operate by thermal conduction or have a heat pipe or thermal siphon associated with it. The heat spreader ring contains elements that efficiently connect to the thermal guide, an example of which includes a ring containing bent fin elements that are thermally connected to the thermal guide. Alternatively, the solid state light sources can be coupled directly to a thermal guide without a heat spreader ring. For the solid state light sources, light 42 can include, for example, LEDs 48, 50, 66, 68, 70, and 72 arranged around ring 46, as shown in FIG. 4. The solid state light sources are in optical communication with optical guide 52; for example, the light sources can be located within hemispherical or other types of depressions in an edge of optical guide 52 and possibly secured through use of an optically clear adhesive.

A base 44 is configured to connect to a power supply, and it can include a power circuit for providing the required voltage and current from the power supply to drive the solid state light sources. Base 44 can be implemented with, for example, an Edison base for use with conventional light bulb sockets or a base for use with conventional fluorescent light fixture connections. Air passages 56 and 58 are provided between optical guide 52 and base 44 to provide free convection across thermal guide 54 through an air passage 60.

In this exemplary embodiment, the thermal guide is implemented with metallic fins 54, 62, and 64, as illustrated in FIG. 3. The fins are integrated with light guide 52, as shown in FIGS. 3 and 4, in order to draw heat from solid state light sources 48, 50, 66, 68, 70, 72 and dissipate the heat through convection or radiation, or both, by air flow in air passage 60. The thermal guide can optionally include a heat pipe or thermal siphon. Optical guide 52 can be implemented with, for example, polycarbonate, polyacrylates such as polymethyl methacrylate, polystyrene, glass, or any number of different plastic materials having sufficiently high refractive indexes for the optical guide to distribute light. The exterior portion of light 42 can be used to distribute and emit light from the solid state light sources, and the interior portion of light 42 is used for cooling the thermal guide and solid state light sources. Optical guide 52 can be formed in a bulb shape, as represented in FIG. 2, or in other shapes. With certain shapes, such as a bulb shape shown in FIG. 2, the interior portion of optical guide 52 can form an interior volume, and the thermal guide can be integrated with the interior volume of the optical guide for providing thermal conduction from the solid state light sources.

FIG. 5 is a cross sectional side view of a solid state light 74 with an active cooling element 88. Light 74 can have a similar construction as light 42. Light 74 includes a base 76, an optical guide 84, a thermal guide 86, and solid state light sources, such as LEDs 80 and 82, arranged on an optional heat spreader ring 78. Active cooling element 88, such as a fan, draws air through air passage 87 for cooling in addition to free convection and radiation. Active cooling element 88 can be coupled to a power source through base 76, and it can run continuously when light 74 is in operation or can include a temperature sensor to activate it only when light 74 is above a certain temperature.

Optical Diffuser with Integrated Thermal Guide

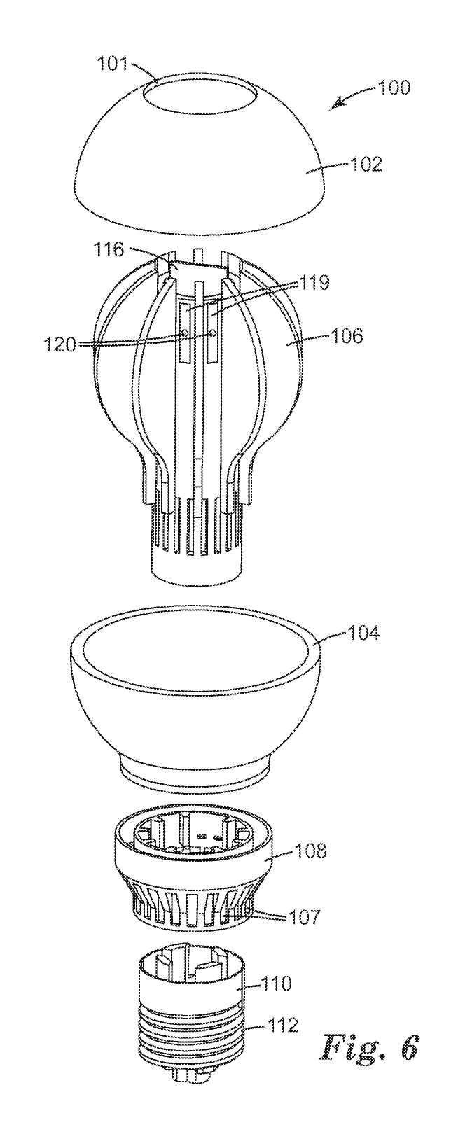

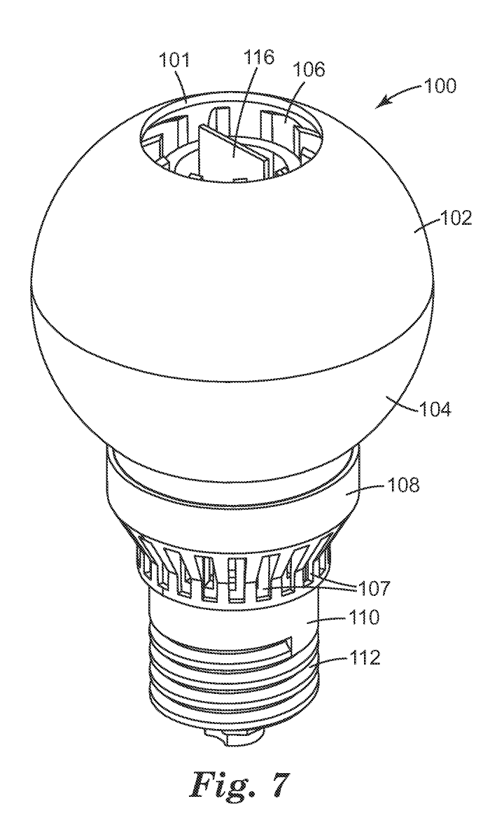

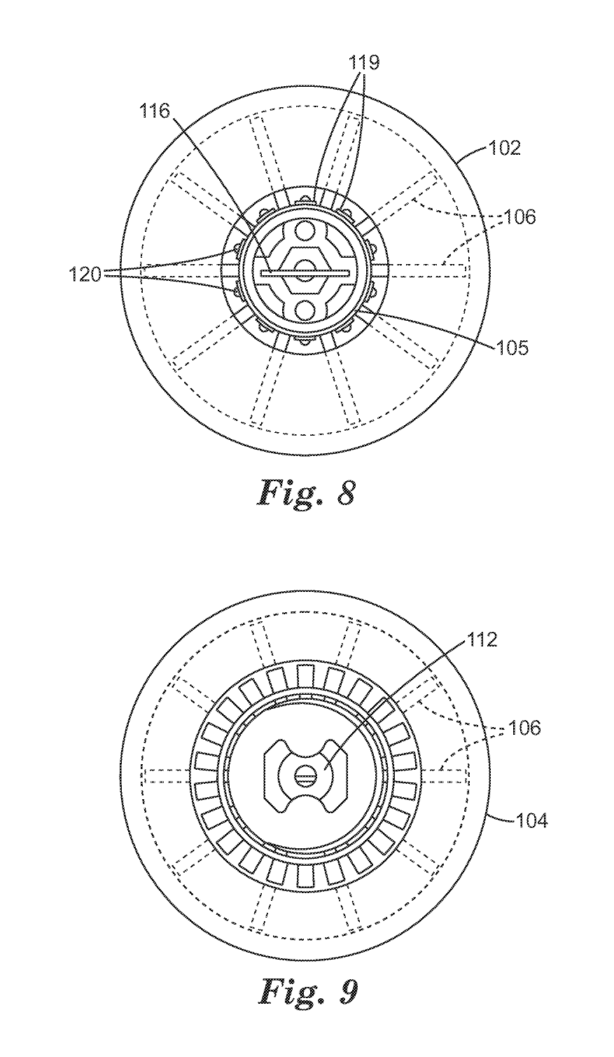

FIG. 6 is an exploded perspective view of a solid state light 100 with an optical diffuser. FIG. 7 is a perspective view of light 100 as assembled, and FIGS. 8 and 9 are top and bottom views, respectively, of light 100. The perspective view in FIG. 7 is looking at the side and top of light 100, which is generally symmetrical from a side view. Light 100 includes an optical diffuser comprised of upper and lower portions 102 and 104, an integrated thermal guide 106, a decorative ring 108, a base portion 110, and a base 112 for electrical connection to a power source such as via conventional light sockets as identified above or other sockets. Although the optical diffuser is shown as having two portions, it can alternatively have more than two portions or be composed of a single continuous piece of material.

As shown in FIGS. 6 and 8, a plurality of solid state light sources 120, such as LEDs, are mounted on thermal guide 106 between each of the fins. Solid state light sources 120 can be mounted on circuits 119, which are electrically connected to circuit 116 for supplying power to the LEDs. Alternatively, the solid state light sources can be mounted directly onto thermal guide 106 and electrically connected with circuit 116. Circuits 119 or solid state light sources 120 can be mounted on the thermal guide by bonding them to the thermal guide with an adhesive or by attaching them in other ways. Also, the solid state light sources need not be mounted between each of the fins, and more than one solid state light source can be mounted between each of the fins or between selected fins of thermal guide 106. The solid state light sources distribute light through the optical diffuser, which can provide for a substantially uniform distribution of light from the exterior surface of the optical diffuser or a particular desired distribution.

As illustrated in FIG. 7, upper portion 102 mates with lower portion 104 to form the optical diffuser, and lower portion 104 mounts to ring 108 in order to secure the optical diffuser to ring 108. Thermal guide 106 is mounted in ring 108 and connected with base portion 110. In this embodiment, thermal guide 106 is also integrated with the optical diffuser as described above for the optical guide. Thermal guide 106 draws heat from the solid state light sources mounted on it through conduction and dissipates the heat through convection or radiation, or both, to cool light 100 and to efficiently utilize both area and volume for the cooling. In this embodiment, thermal guide 106 resides completely with the optical diffuser, meaning the cooling fins of thermal guide 106 do not penetrate through the optical diffuser or optical guide.

As shown in FIG. 6, thermal guide 106 has a central core connected with external curved fins, which can conform to the shape of the optical diffuser. Also, thermal guide 106 can optionally include a reflective coating on its exterior surface. Thermal guide 106 can be covered with a reflective coating or paint such as the Starbrite II water primer from Spraylat Corporation, Chicago, Ill., which provides a white surface finish. One type of reflective coating or paint reflects visible light and emits IR light. The components of light 100 can be implemented with the exemplary materials and components identified above with the optical diffuser being implemented with the same materials, for example, as identified above for the optical guide. Light 100 can optionally include an active cooling element as illustrated in FIG. 5.

An air passage 101 in upper portion 102 along with apertures 107 in ring 108 allow air flow across thermal guide 106, and this type of air flow is illustrated by the arrows in FIG. 2. Alternatively, the air passage can be located at other locations of the optical diffuser and need not necessarily be at the top of the diffuser. The top edge of upper portion 102, forming air passage 101, can be lined with a reflective film 105 (shown in FIG. 8) so that light traversing the optical diffuser instead of being transmitted through it is reflected back down the diffuser when it reaches the top edge in order to be distributed through the exterior or interior surfaces of the optical diffuser. An example of a reflective film is the Enhanced Specular Reflector (ESR) film product from 3M Company, St. Paul, Minn.

Circuitry 116, such as a printed circuit board, can be mounted in the central core of thermal guide 106 such as within a slot as shown in FIG. 7. When mounted, circuitry 116 is electrically connected with solid state light sources on circuits 119. Circuitry 116 receives power from a power supply via base 112 and provides the required voltage and current to drive the solid state light sources. Circuitry 116 can be thermally coupled to the thermal guide in order to help cool the electronic components.

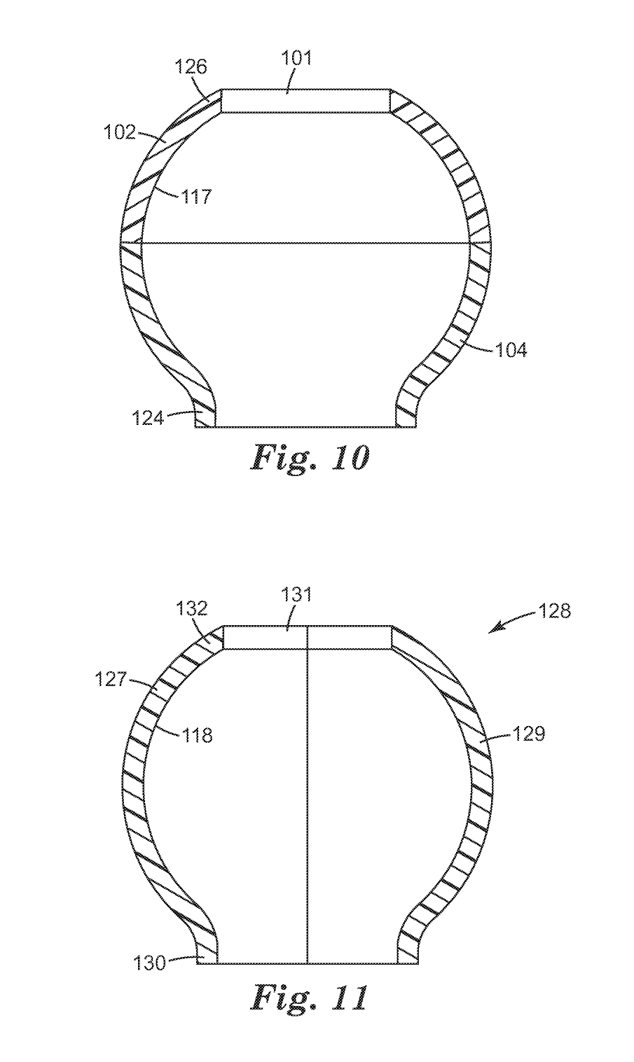

FIG. 10 is a cross sectional side view of the optical diffuser illustrating upper portion 102 and lower portion 104. In this optical diffuser upper portion 102 mates with lower portion 104 with a horizontal seam parallel to ring 108. Upper portion 102 includes air passage 101 providing for air flow across the thermal guide.

FIG. 11 is a cross sectional side view of another optical diffuser 128 as an alternative embodiment of the optical diffuser for light 100. Optical diffuser 128 includes a left portion 127 that mates with a right portion 129 with a vertical seam perpendicular to ring 108. Left and right portions 127 and 129 together form an air passage 131 providing for air flow across the thermal guide.

Interior surfaces 117 and 118 of the optical diffusers shown in FIGS. 10 and 11, respectively, can be sandblasted in order to roughen the internal surface to provide for substantially uniform distribution of light from the solid state light sources and through the optical diffuser. Sandblasting or roughening the interior surfaces also provides the light with a diffusive or frosted appearance when the light sources are on or off. The optical diffusers can also include other types of light extraction features. A material to make the optical diffusers can optionally include diffusive particles or a color shifting material.

The optical diffuser or a portion of it can optionally be tapered. For example, in the optical diffuser shown in FIG. 10 the thickness of lower portion 104 can be substantially constant from bottom edge 124, while the thickness of upper portion 102 can taper from the thickness of lower portion 104 to a top edge 126. This type of taper involves a discontinuous taper, meaning only a portion of the optical diffuser is tapered. Alternatively and as another example, in optical diffuser 128 left portion 127 can taper from a bottom edge 130 to a top edge 132, and right portion 129 can taper in a likewise manner. This type of taper involves a continuous taper, meaning the entire optical diffuser is tapered. For either the optional discontinuous or continuous taper, the amount of taper can be varied based upon a desired distribution of light output, for example, and the amount of tapering can be determined using empirical evidence, modeling, or other techniques.

Optical guide 52 in light 42 (FIG. 2) and optical diffuser 102 and 104 in light 100 (FIG. 6) can each optionally include a functional coating on their interior surfaces, exterior surfaces, or both. Examples of functional coatings include the following. Coatings with optical functions include coatings to provide for anti-reflection, radiation shielding, photoluminescence, and IR emission for passive temperature control. Coatings with physical and mechanical functions include coatings to provide for anti-abrasion, scratch resistance, and hard coats. Coatings with chemical and thermodynamic functions include coatings to provide for dirt repellence and anti-corrosion. Coatings with biological functions include coatings to provide for anti-microbial properties. Coatings with electromagnetic solid state functions include coatings to provide for anti-static and electromagnetic shielding. A coating could provide for optical properties, for example, a low index coating can be provided such that the optical guide will always operate in total internal reflection, despite external influences such as condensation, dirt buildup, deposits from cooking, soot, or other sources.

The embodiment using an optical guide shown in FIGS. 2-4 can be combined with the embodiment using an optical diffuser shown in FIGS. 6-8. The combined embodiment would have both an optical diffuser and an optical guide in order to better diffuse light emanating from the optical guide itself.

1. A light with an integrated optical diffuser and thermal guide, comprising:
a light source;
an optical diffuser in communication to the light source for receiving and distributing light from the light source; and
a thermal guide integrated with the optical diffuser for providing thermal conduction from the light source for cooling the light,
wherein the light source is mounted on the thermal guide.

2. The light of claim 1, wherein the light source comprises one or more of the following: a light emitting diode; and an organic light emitting diode.

3. The light of claim 1, further comprising a circuit for providing power to the light source.

4. The light of claim 1, wherein the thermal guide has a central core connected with external fins.

5. The light of claim 4, wherein the fins are curved and conform to a shape of the optical diffuser.

6. The light of claim 4, wherein the light includes light emitting diodes between each of the fins.

7. The light of claim 1, wherein the optical diffuser has an air passage.

8. The light of claim 1, wherein the optical diffuser comprises an upper portion and a lower portion, wherein the upper portion is separable from the lower portion.

9. The light of claim 1, wherein the optical diffuser comprises a left portion and a right portion, wherein the left portion is separable from the right portion.

10. The light of claim 1, further comprising a reflective film located on the top edge of the optical diffuser.

11. The light of claim 1, wherein the thermal guide has a reflective surface.

12. The light of claim 1, further comprising a coating applied to an external surface of the thermal guide, wherein the coating is reflective to visible light and emissive to infrared light.

13. The light of claim 1, wherein the light source is mounted directly on the thermal guide.

14. The light of claim 1, wherein the light source is mounted on a circuit, and the circuit is mounted directly on the thermal guide.

15. The light of claim 1, wherein the optical diffuser has a roughened internal surface.

16. The light of claim 1, further comprising a functional coating applied to the optical diffuser.

17. A light with integrated optical and thermal guides, comprising:
a light source;
an optical guide coupled to the light source for receiving and distributing light from the light source;
a thermal guide integrated with the optical guide for providing thermal conduction from the light source for cooling the light; and
a functional coating applied to the optical guide.
